(19) United States
(12) Patent Application Publication
(10) Pub. No.: US 2026/0222315 A1
(43) Pub. Date: Jul. 30, 2026

(54) WIRELESS COMMUNICATION SYSTEM AND METHOD FOR COLLECTING AI/ML DATA

(71) Applicant: SHENZHEN TCL NEW TECHNOLOGY CO., LTD., Shenzhen, Guangdong (CN)

(72) Inventors: Miao QU, Shenzhen, Guangdong (CN); Xiaoyong TANG, Shenzhen, Guangdong (CN)

(73) Assignee: SHENZHEN TCL NEW TECHNOLOGY CO., LTD., Shenzhen, Guangdong (CN)

(21) Appl. No.: 19/145,187

(22) PCT Filed: Feb. 17, 2023
(86) PCT No.: PCT/CN2023/076942

§ 371 Date: Jul. 1, 2025

(51) Int. Cl. H04L 41/16; H04L 43/0876

(52) U.S. Cl. CPC H04L 41/16; H04L 43/0876

(57) ABSTRACT

A method for collecting artificial intelligence (AI)/machine learning (ML) data information in wireless communication system includes: a user equipment (UE) sends a message to a network (NW) which is used to request some AI data information from NW; and UE receives a message with response from NW, wherein content of response is corresponding with NW decision. Further, A method for collecting AI/ML data information in wireless communication system includes: NW receives request message with an AI/ML data request from UE; NW make a decision whether to send AI/ML data information to UE; and NW sends a message with response to UE, wherein content of response is corresponding with NW decision, if NW agrees to send AI data to UE, message carries required AI data information; if NW reject to send AI data to UE, message carries a reject reason.

### BACKGROUND OF DISCLOSURE

### 1. Field of the Disclosure

The present disclosure relates to the field of wireless communication systems, and more particularly, to a wireless communication system and a method for artificial intelligence (AI)/machine learning (ML) data collection from different entities, such as UE, NW (gNB, LMF) in wireless communication system. More specifically, the target is to collect suitable AI data properly and effectively. The present disclosure may decrease signaling overhead and transmission conflicts in wireless communication system.

### 2. Description of the Related Art

For the study AI/ML over air inference, the general framework agreed in RAN3 TR 37.817 is regarded as start point, which is depicted in FIG. 7, it is shows the data collection is useful to some AI actions, such as model training and model inference. With the meeting progress and fully discussion for AI/ML over air inference, a conclusion of data collection has been achieved in RAN1 #110bis, details are as followings:
Conclusion:
   Data collection may be performed for different purposes in LCM, e.g., model training, model inference, model monitoring, model selection, model update, etc. each may be done with different requirements and potential specification impact.

It is noted that the collected data for different aspects of LCM is important, hence, the methods of data collection should be considered. In RAN1 #111 meeting, some companies proposed that by enhancing the legacy measurement/report to collect required data, i.e., CSI measurement, meanwhile, several companies also pointed out to define a new procedure to achieve the data collection, such like use a new RRC message. However, the data collection procedure is still unclear, including the signaling and elements. Moreover, no matter what the enhanced legacy measurement or newly defined RRC message in the above discussion, it limits the data which is only collected from the active UE. That is, it is unable to get the data from the idle or inactive UE if the scenario needs the data from UE. Considering that some AI actions may require a quantity of data to improve the performance of AI model, such as model training, collecting data only from active UE may can not satisfy above requirement in a valid time. Therefore, it is reasonable to study the data collection for idle or inactive UE.

Considering that data collection plays a key role in the AI model's life cycle management (LCM), specifically, the collected data can be regarded as input for AI related functions/actions, such like model training, model monitoring and so on. As RANI discussion and evaluation, the input is different for different use cases. For instance, in CSI feedback enhancement, the raw channel and eigenvectors are needed, For beam management, L1-RSRP and/or beam ID are useful to different sub-use cases. While channel impulse information (CIR) is necessary for positioning enhancement. Besides, some information may also be regarded as input, such as UE location, cell ID, area ID, site ID, scenario ID, zone ID, carrier frequency, accuracy and so on. As above discussion, it is noted that the collected data is various for AI-based method in wireless system.

Therefore, based on the above discussion, the method of collecting AI-specific data from all RRC states UE, and/or NW must be studied in different use cases combined different AI model types (one-sided model and two-sided model) in the future.

### SUMMARY

An object of the present disclosure is to propose a wireless communication system and a method for determining artificial intelligence (AI)/machine learning (ML) model during user equipment (UE) mobility, to provide the methods for collecting AI-specific data from all RRC states UE, and/or NW, which is not discussed in current study and decrease signaling overhead and transmission conflicts in wireless communication system.

In a first aspect of the present disclosure, a method for collecting artificial intelligence (AI)/machine learning (ML) data information in wireless communication system includes User equipment (UE) sends a message to network (NW), wherein the message is used to request some AI data information from NW, wherein the message is sent by a newly defined and/or a reused legacy message, wherein the operation of UE sends a message to NW is optional; and UE receives a message with response from NW, wherein the content of response is corresponding with NW choice, if NW chooses to send AI data information to UE, the message with response carries required AI data information.

In a second aspect of the present disclosure, a method for collecting artificial intelligence (AI)/machine learning (ML) data information in wireless communication system includes: Network (NW,) receives request message with AI/ML data request from user equipment (UE), wherein the operation of NW receives request message is optional; NW chooses at least one of the followings: send AI/ML data information to UE; suspend to send AI/ML data information; reject to UE; wherein the choice is based on UE request if it exits, and/or based on NW itself; and NW sends a message with response to UE, wherein the content of response is corresponding with NW choice, if NW chooses to send AI data information to UE, the message with response carries required AI data information.

In a third aspect of the present disclosure, a method for collecting artificial intelligence (AI)/machine learning (ML) data information in wireless communication system includes: Network (NW) sends a message to user equipment (UE), wherein the message is used to request some AI data information from UE, wherein the message is sent by system information, or/and dedicated RRC message, wherein the operation of NW sends a message to UE is optional; and NW receives a message with response from UE, wherein the content of response is corresponding with UE choice, if UE chooses to report AI data to NW, the message with response carries required AI data information.

In a fourth aspect of the present disclosure, a method for collecting artificial intelligence (AI)/machine learning (ML) data information in wireless communication system includes: User equipment (UE) receives request message with AI/ML data request from network(NW), wherein the operation of UE receives request message is optional; UE chooses at least one of the followings: send AI/ML data information to NE, suspend to send AI/ML data information, reject to NW; wherein the choice is based on NW request if it exits, and/or based on UE itself; and UE sends a message with response to NW, wherein the content of response is corresponding with UE choice, if UE chooses to report AI data information to NW, the message with response carries required AI data information.

In a fifth aspect of the present disclosure, a wireless communication system comprises a memory, a transceiver, and a processor coupled to the memory and the transceiver. The processor is configured to perform the above method.

In a sixth aspect of the present disclosure, a non-transitory machine-readable storage medium has stored thereon instructions that, when executed by a computer, cause the computer to perform the above method.

In a seventh aspect of the present disclosure, a chip includes a processor, configured to call and run a computer program stored in a memory, to cause a device in which the chip is installed to execute the above method.

In an eighth aspect of the present disclosure, a computer readable storage medium, in which a computer program is stored, causes a computer to execute the above method.

In a ninth aspect of the present disclosure, a computer program product includes a computer program, and the computer program causes a computer to execute the above method.

In a tenth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipment and a network/gNB of communication in a communication network system according to an embodiment of the present disclosure.

FIG. 2A is a flowchart illustrating a method for collecting an artificial intelligence (AI)/machine learning (ML) data information in a wireless communication system according to an embodiment of the present disclosure.

FIG. 2B is a flowchart illustrating a method for collecting an artificial intelligence (AI)/machine learning (ML) data information in a wireless communication system according to an embodiment of the present disclosure.

FIG. 3A is a flowchart illustrating a method for collecting an artificial intelligence (AI)/machine learning (ML) data information in a wireless communication system according to an embodiment of the present disclosure.

FIG. 3B is a flowchart illustrating a method for collecting an artificial intelligence (AI)/machine learning (ML) data information in a wireless communication system according to an embodiment of the present disclosure.

FIG. 4A is a schematic diagram illustrating an example of procedure of UE collects AI data information from NW according to an embodiment of the present disclosure.

FIG. 4B is a schematic diagram illustrating an example of procedure of UE collects AI data information from NW according to an embodiment of the present disclosure.

FIG. 5A is a schematic diagram illustrating an example of procedure of NW collects AI data information from UE according to an embodiment of the present disclosure.

FIG. 5B is a schematic diagram illustrating an example of procedure of NW collects AI data information from UE according to an embodiment of the present disclosure.

FIG. 6 is a block diagram of a system for wireless communication according to an embodiment of the present disclosure.

FIG. 7 is an AI general framework for wireless communication in prior art.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

This invention is related to wireless communication system, where the AI/ML algorithms are enabled over RAN, the relevant new SID on AI/ML for NR Air Interface of the Rel.18, which is approved in 3GPP RAN plenary meetings 94e in Dec. 2022, and the related discussion is led by RAN 1 and begins in May 2022. This invention provides the methods of AI data collection from different entities, such as UE, NW (gNB, LMF) in wireless communication system. More specifically, through collecting suitable AI data properly and effectively, the signaling overhead and transmission conflicts can be decreased in wireless communication. In this disclosure, the methods of AI data collection which include the procedure and parameters are proposed. It's had not been discussed by RAN1 meeting and RAN2 meeting, but straightforward according to the currently Tdocs discussion.

### Invention Effect

Provide the methods for AI data collection, which is not discussed in current study;

Decrease the overhead and conflicts and assist AI function work efficiently by improve the collected AI data.

### Identified Problems

Three types of AI model were agreed in RAN1, including UE-sided model, NW-sided model and two-side model. We first analyze and identify the problems of data collection in different AI model cases.

### Case1: Data Collection in UE-Sided Model

In the UE-sided model, model inference is located UE side. The UE can obtain AI data information for model inference by measuring downlink channel since NW can provide any possible AI data information. However, for measuring uplink channel in the legacy measurement, there is no need to feedback information to UE because the measure results depend on NW implementation. However, some AI data information is required to collect for model inference function at UE, which is needed to process and assist inference. Hence, in UE-sided model, how UE collects the AI data information from NW is needed to be clarified.

### Case2: Data Collection in NW-Sided Model

In the NW-sided model, model inference is located NW side. In order to obtain the AI data information from NW to active UE, the legacy measurement method reporting (i.e., L1-measurement) seems can be reused directly since it can report L1-RSRP, CQI, CIR and etc. to UE. However, when model monitoring is located at UE side in NW-sided model case, the output of model monitoring can be used to model inference to assist model inference, which is an agreement during RAN1 meeting. The output of model monitoring, such as accuracy, predicted outcome and etc., can be regarded as AI data, it is new characteristics which are not appeared in the legacy measurements reporting. Moreover, if the RRC state of UE is idle/inactive in the NW-sided model, UE can get the measure results (RSRP, RSRQ, SINR) through the exiting L3-measurement, but there is also no report to NW side since the initial aim of L3 measurement is to do cell selection and reselection by UE. Nevertheless, if the model inference function at NW needs to collect some AI data information for processing inference from idle/inactive UE, idle/inactive UE needs to report AI data information to NW. Above these two sub-cases, how NW collect the AI data information from active/inactive/active UE in NW-sided model is needed to be clarified.

### Case3: Data Collection in Two-Sided Model

In the two-sided model, model inference is performed jointly across the UE and the network, i.e., the first part of inference is firstly performed by UE and then the remaining part is performed by gNB, or vice versa. Hence, if only consider the model inference function, it is easily to see that AI data information is also needed to be gathered between both side (NW, UE). The same issues about AI data collection are raised as discussed in case1 and case2.

Moreover, as discussed above, AI data is needed to be collected and used to different AI functions, including model inference, model training, model monitoring, model updating, and etc., it is found some problems are identified in one case is also existed in another case. For example, in case1, if the model training in NW side, the model training needs to collect AI data from idle/inactive UE, while existing L3 measurement has no report from UE to NW, it is the same problem we discussed in case2.

As mention above, considering the locations of AI functions can be UE side, and NW side, the issues of data collection can be summarized as followings:
Issue1: How UE collects the AI data information from NW
Issue2: How NW collects the AI data information from UE

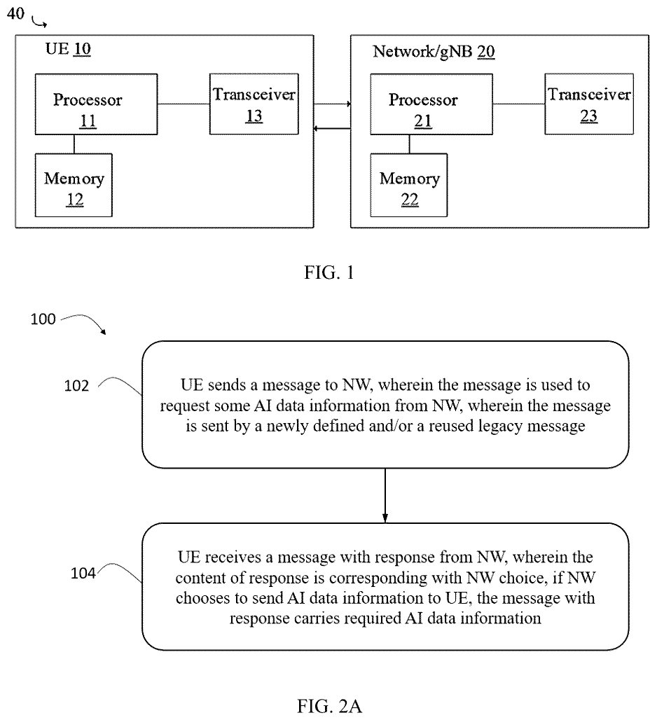

FIG. 1 illustrates that, in some embodiments, one or more user equipments (UEs) 10 and a network/gNB 20 for communication in a communication network system 40 according to an embodiment of the present disclosure are provided. The communication network system 40 includes one or more UEs 10 and a network/gNB 20. The one or more UEs 10 may include a memory 12, a transceiver 13, and a processor 11 coupled to the memory 12 and the transceiver 13. The network/gNB 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

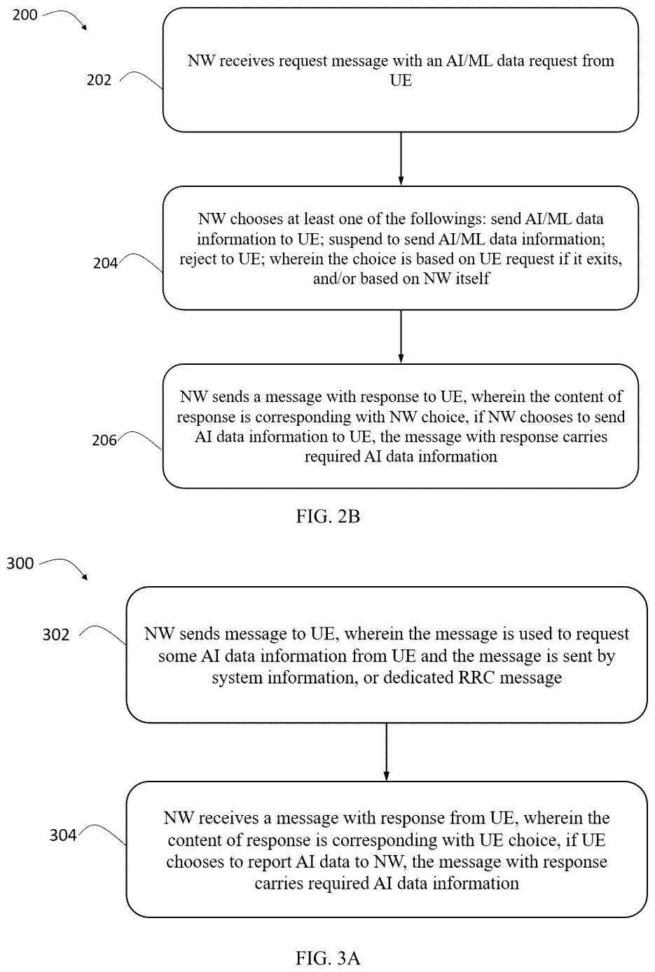

FIG. 2A illustrates a method for collecting an artificial intelligence (AI)/machine learning (ML) data information in a wireless communication system according to an embodiment of the present disclosure. In some embodiments, a method 100 for collecting artificial intelligence (AI)/machine learning (ML) data information in wireless communication system includes: step 102: User equipment (UE) sends a message to network (NW), wherein the message is used to request some AI data information from NW, wherein the message is sent by a newly defined and/or a reused legacy message, wherein the operation of UE sends a message to NW is optional; and step 104: UE receives a message with response from NW, wherein the content of response is corresponding with NW choice, if NW chooses to send AI data information to UE, the message with response carries required AI data information.

FIG. 2B illustrates a method for collecting an artificial intelligence (AI)/machine learning (ML) data information in a wireless communication system according to an embodiment of the present disclosure. In some embodiments, a method 200 for collecting artificial intelligence (AI)/machine learning (ML) data information in wireless communication system includes: step 202: Network (NW,) receives request message with AI/ML data request from user equipment (UE), wherein the operation of NW receives request message is optional; step 204: NW chooses at least one of the followings: send AI/ML data information to UE; suspend to send AI/ML data information; reject to UE; wherein the choice is based on UE request if it exits, and/or based on NW itself; and step 206: NW sends a message with response to UE, wherein the content of response is corresponding with NW choice, if NW chooses to send AI data information to UE, the message with response carries required AI data information.

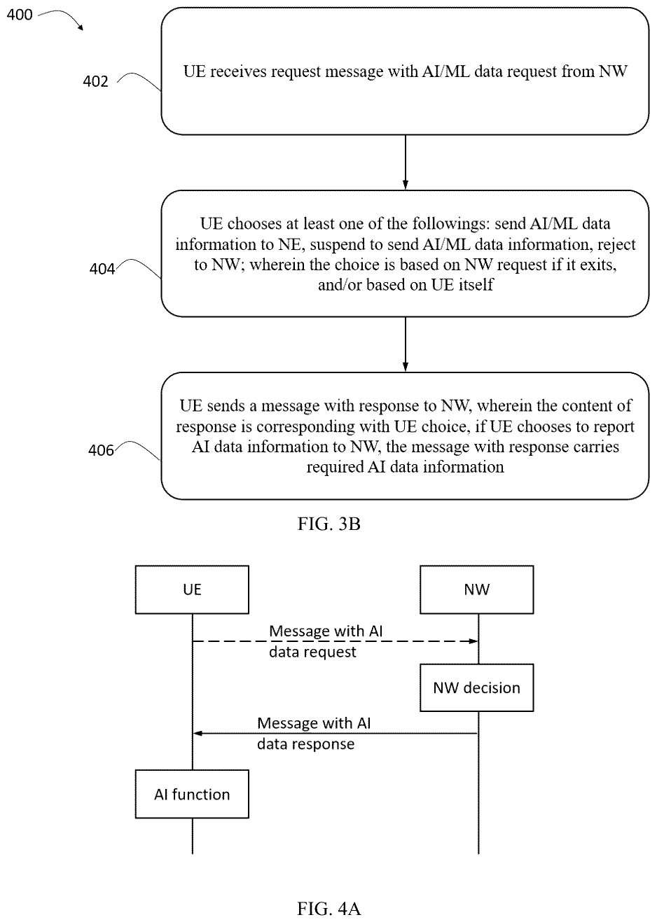

FIG. 3A illustrates a method for collecting an artificial intelligence (AI)/machine learning (ML) data information in a wireless communication system according to an embodiment of the present disclosure. In some embodiments, a method 300 for collecting artificial intelligence (AI)/machine learning (ML) data information in wireless communication system includes: step 302: Network (NW) sends a message to user equipment (UE), wherein the message is used to request some AI data information from UE, wherein the message is sent by system information, or/and dedicated RRC message, wherein the operation of NW sends a message to UE is optional; and step 304: NW receives a message with response from UE, wherein the content of response is corresponding with UE choice, if UE chooses to report AI data to NW, the message with response carries required AI data information.

FIG. 3B illustrates a method for collecting an artificial intelligence (AI)/machine learning (ML) data information in a wireless communication system according to an embodiment of the present disclosure. In some embodiments, a method 400 for collecting artificial intelligence (AI)/machine learning (ML) data information in wireless communication system includes: step 402: User equipment (UE) receives request message with AI/ML data request from network(NW), wherein the operation of UE receives request message is optional; step 404: UE chooses at least one of the followings: send AI/ML data information to NE, suspend to send AI/ML data information, reject to NW; wherein the choice is based on NW request if it exits, and/or based on UE itself; and step 406: UE sends a message with response to NW, wherein the content of response is corresponding with UE choice, if UE chooses to report AI data information to NW, the message with response carries required AI data information.

In some embodiments, for procedure of NW collect data from idle/inactive UE, the method comprising: NW initial: NW sends a request message to idle/inactive UE for requiring AI data information, and receives a response from idle/inactive UE according to configuration information in request message, wherein the AI data information is provided in response message.

In some embodiments, for procedure of NW collect data from idle/inactive UE, the method comprising: UE autonomous: UE autonomously sends AI data information to NW.

In some embodiments, if AI data type that NW needed only is obtained by L1-measurement, and if the UE report these types of AI data to NW, UE sends an indication for triggering NW initial related measurement of AI data collection to get the AI data information, wherein the indication is included in the message with response and sent by RACH or dedicated RRC massage.

In some embodiments, If AI data that NW needed only obtained by L3-measurement or/and non-measurement, the AI data information can be sent to NW as the following options:
Option1: idle/inactive UE send AI data information to NW by RACH or grant free transmission, while idle/inactive UE does not need to be transmitted active UE;
Option2: idle/inactive UE send AI data information to NW by RRC dedicated, and/or UP traffic, while idle/inactive UE needs to transmit active UE and establish connection between UE and NW.

In some embodiments, the method for collecting the AI/ML data in the wireless communication system further comprising a new threshold defined to assist UE to decided use which options to transmit AI data information, wherein new threshold is based on data size.

In some embodiments, the message used to request some AI data information comprises at least one of the followings:
indication for AI/ML data type, indicating which type of AI/ML data is needed to collect;
AI/ML function ID, indicating which AI functions want to collect AI/ML-specific data such as a model training function, a model monitoring function, a model monitoring function, and/or a model update function;
cause of AI/ML data, indicating a reason for AI/ML data collection;
threshold of AI/ML data size, indicating a maximum, and/or a minimum size/number of collected AI/ML data;
duration of AI/ML data collection, indicating a maximum, and/or a minimum duration of AI/ML data collection;
quality of AI/ML data, indicating a quality of AI/ML data collection described as accuracy or validity;
model ID, indicating AI/ML model and/or function of AI/ML model; and/or
response type, indicating a response type can be periodic, aperiodic, or event-trigger.

In some embodiments, content of AI data can be decided by NW or UE itself or fixed, content of AI/ML data comprises: channel quality indicator (CQI), precoding matrix indicator (PMI), rank indicator (RI), channel impulse response (CIR), layer one reference signal received power (L1-RSRP), beam indicator (ID), NW location information, cell ID, area ID, site ID, scenario ID, zone ID, carrier frequency, and/or accuracy, and message with AI data can be sent by unicast, groupcast, or broadcast.

In some embodiments, the method for collecting the AI/ML data in the wireless communication system further comprising options to indicate AI data type:
Option1: Indicate AI data type precisely, wherein an indication clearly indicates one type of required AI data;
Option2: Indicate a set/group of required AI-specific data type, wherein an indication clearly indicates several types of required AI data, set/group can be based on use cases, per cell, per zone, and/or by means of obtaining required AI data.

In some embodiments, when NW receives message with AI data request, NW initiates AI-specific measurement operation for data collection, wherein the initiation may be triggered message, and/or a newly defined indication in message, and/or NW delivers AI data directly, which may be based on statistics of NW.

In some embodiments, message sent by UE to NW to request AI data including threshold of AI data size/number, wherein threshold of AI data size/number is defined as following:
Option1: Fixed, wherein AI data size threshold is fixed by analysis and evaluation;
Option2: UE calculate, wherein UE calculates minimum AI data size which it needs and maximum AI data size which it can store, wherein the calculation is based on UE capability, memory, reminding required type AI data that UE has store, or use cases.

In some embodiments, parameters in message is by indicator, string, and/or bitmap, and message transfers in dedicated RRC message, PUSCH, PUCCH, RACH, NAS and etc., response message transfers in system information, dedicated RRC message, UP traffic, NAS and etc., wherein AI data collection can be periodic, on-demand, or event trigger.

In some embodiments, a user equipment, comprising: a memory; a transceiver; and a processor coupled to the memory and the transceiver; wherein the processor is configured to execute the method of any one of above embodiment.

In some embodiments, a non-transitory machine-readable storage medium having stored thereon instructions that, when executed by a computer, cause the computer to perform the method of any one of above embodiment.

In some embodiments, a chip, comprising: a processor, configured to call and run a computer program stored in a memory, to cause a device in which the chip is installed to execute the method of any one of above embodiment.

In some embodiments, a computer readable storage medium, in which a computer program is stored, wherein the computer program causes a computer to execute the method of any one of above embodiment.

In some embodiments, a computer program product, comprising a computer program, wherein the computer program causes a computer to execute the method of any one of claims 1 to 18.

A computer program, wherein the computer program causes a computer to execute the method of any one of above embodiment.

In order to collect the AI data from NW and UE for different AI functions, the following solutions have been proposed in this disclosure patent, which is useful for different use cases with corresponding AI models, such as CSI enhancement, beam management, positioning enhancement and etc.

### The Procedure of UE Collects AI Data from NW

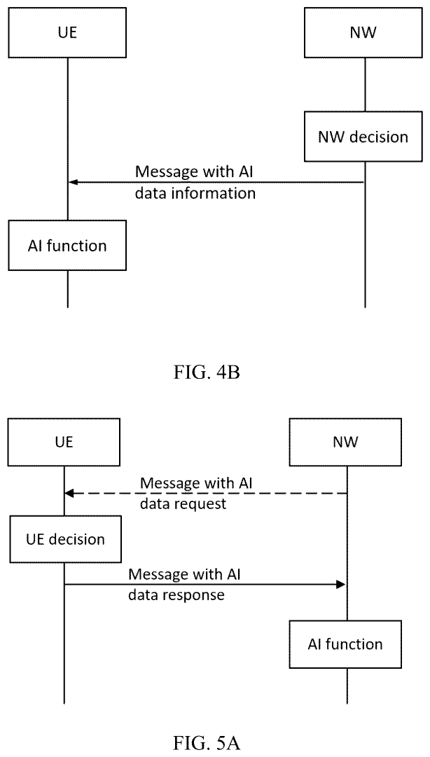

When the AI functions are deployed at UE side, the UE needs to collect AI data information from NW is shown in FIGS. 4A and 4B, the potential procedures are as followings, and implementation method as shown in embodiment 1.
Step1: UE sends message to NW, which is used to request some AI data information from NW. The message includes at least one of the followings: indication for AI data type, AI function ID, cause of AI data collection, threshold of AI data size, duration of AI data collection, quality of AI data, model ID, UE ID, Response type and so on. This step1 may be optional;
Step2: NW do a decision about whether sends the AI data information, the decision can be based on step1 if it exits, and/or based on NW itself. Moreover, the decision may be one of the followings: 1) agree to send the AI data information to UE; 2) agree but suspend to send the AI data information; 3) disagree, send the reject to UE;
Step3: NW sends Message with the response to UE, the content of response is corresponding with the above NW decision. If the NW agree to send the AI data to UE, the Message may carry the required AI data information; if the NW reject to send the AI data to UE, the Message may carry the reject reason.

### The Procedure of NW Collect Data from UE

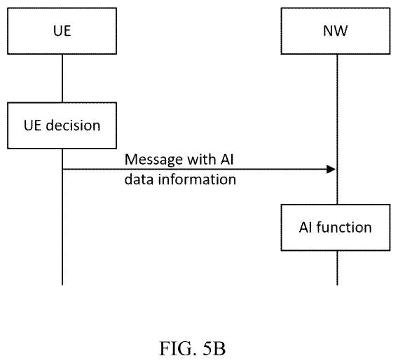

When the AI functions are deployed at NW side, the NW needs to collect AI data information from UE is shown in FIGS. 5A and 5B, the potential procedures are as followings and implementation method as shown in embodiment 2 and 3.
Step1: NW sends message to NW, which is used to request some AI data information from UE. The message includes at least one of the followings: indication for AI data type, AI function ID, cause of AI data collection, threshold of AI data size, duration of AI data collection, quality of AI data, model ID and Response type so on. The message can be sent by system information, dedicated RRC message. Moreover, this step1 may be optional;
Step2: UE do a decision about whether sends the AI data information, the decision can be based on step1 if it exits, and/or based on UE itself. Moreover, the decision may be one of the followings: 1) agree to send the AI data information to UE; 2) agree but suspend to send the AI data information; 3) disagree, send the reject to UE;
Step3: UE sends Message with the response to UE, the content of response is corresponding with the above UE decision. If the UE agrees to report the AI data to NW, the Message may carry the required AI data information; if the UE rejects to send the AI data to NW, the Message may carry the reject reason.

### Embodiments

### Embodiment 1: The Procedure of UE Collects Data from NW

When AI functions are deployed in UE side, in order to initial and process the related function, AI data information is needed to collect from NW. There are two alternatives for UE to gather AI data information:
Alternative1: UE request: through UE send a request message to NW for requiring AI data information, NW sends a response to UE according to the parameters and information in request message, the AI data information is provided in the response message;
Alternative2: NW autonomous: NW autonomously sends AI data information to UE.

The procedures of above alternatives are shown in FIGS. 4A, 4B. In Alternative1, as depicted in FIG. 4A, the procedure of UE collects AI data information is provided as follows:
Step1: UE sends message to NW through newly defined, and/or reused legacy message, which is used to request AI data information from NW. message includes at least one of the followings:
   Indication for AI data type: which indicates which type of AI data is needed to collect; or
   AI function ID: which indicates which AI functions want to collect AI-specific data, such as model training function, model monitoring function, model monitoring function, model update function, and etc.; or
   Cause of AI data: which means the reason for AI data collection.
   Threshold of AI data size: which indicates the maximum, and/or minimum size/number of collected AI data; or
   Duration of AI data collection: which indicates the maximum, and/or minimum duration of AI data collection; or
   Quality of AI data: which indicates the quality of AI data collection, the quality can be described as accuracy, validity and so on; or
   Model ID: Which is the indicator for AI model, and/or function of AI model; or
   UE ID: it indicates which UE wants to collect AI data; or
Response type: it indicates the response type can be periodic, aperiodic, event-trigger and so on.
Step2: NW receive the message with AI data request, it will do a decision, the decision can be: send with the AI data information to UE, suspend the AI data request, or reject the AI data request.

Step3: NW sends the response in Message to UE. If the NW agrees to send the AI data to UE, the Message may carry the required AI data information, if the NW reject to send the AI data to UE, the Message may carry the reject reason.

In Alternative2, as depicted in FIG. 4B, the data collection procedure of UE is provided as follows:
Step1: NW sends the AI data information in message to UE, the content of AI data can be decided by NW self, or fixed. The content of AI data may be: CQI, PMI, RI, CIR, L1-RSRP, Beam ID, NW location information, cell ID, area ID, site ID, scenario ID, zone ID, carrier frequency, accuracy and so on. Moreover, the message can be sent by unicast, groupcast, broadcast.

In some examples, for collecting AI data, UE sends the message to NW which may include the indication for AI data type. There are several options to indicate the AI data type:
Option1: Indicate the AI data type precisely, which means an indication clearly indicate one type of required AI data, such as CQI, PMI, RI, CIR, L1-RSRP, Beam ID, NW location, perdition result, cell ID, area ID, site ID, scenario ID, zone ID, carrier frequency, accuracy, and so on. For example, LI-RSRPrequest indicates that the UE requires L1-RSRP AI data, NWlocationrequest indicates that the entity requires the UE requires NW location information AI data; or
Option2: Indicate a set/group of required AI-specific data type, which means an indication clearly indicates several types of required AI data. The set/group can be based for per use case, or per cell, or zone, or means of obtaining the required AI data. For instance, CSIAIdatarequest indicates that the entity requires the AI-specific data of CSI use case, such as the raw channel, eigenvectors and etc. 1) per use case; it means which use case/scenario needs to collect data, i.e, CSI enhancement, beam management, positioning enhancement and etc; 2) per cell, it means which cell needs to collect data, for example, a UE in the cell request AI data to NW, other UEs in the cell may also request AI data to NW; 3) per zone, it means which zone needs to collect data, the zone can be based on geographic position. for example, a UE in the zone request AI data to NW, other UEs in the zone may also request AI data to NW; 4) means of obtaining the required AI data, some AI data can be by measurement, such as CIR, CQI, L1-RSRP, RI and etc., some AI data can be by non-measurement, such as carrier frequency, accuracy, perdition result and etc.

NW receives the message with AI data request, it will do a decision, the decision can be: send the AI data information to UE, or suspend the AI data transfer, or reject the AI data request. Moreover, if the AI data is obtain by measurement, such as CQI, PMI, RI, CIR, L1-RSRP, Beam ID, NW will initiate AI-specific measurement operation for data collection, the initiation may be triggered this Msq1, and/or a newly defined indication in Message which means to trigger NW enable AI-specific measurement operation for data collection; if the AI data is obtained by non-measurement, NW will deliver the AI data directly, which may be based on its statistics.

In some examples, UE sends the Message to NW to request AI data, which may include the indication of AI data type and threshold of AI data size/number, there may be a relationship between AI data and AI data size. By this, NW is notified which type AI data is needed to be transferred and how much this AI data type is need to be transferred. Moreover, the threshold of AI data size/number can be defined as following:
Option1: Fixed, which means the AI data size threshold is fixed by analysis and evaluation;
Option2: UE calculate, UE calculates the minimum AI data size which it needs, and maximum AI data size which it can store, the calculation can be based on UE capability, memory, the reminding required type AI data that UE has store, use cases

NW receives the Message with AI data request, which includes the indication of AI data type and threshold of AI data size/number. It will do a decision, the decision can be sent the proper AI data information (including AI data type and AI data size/number) to UE, or suspend the AI data transfer, or reject the AI data request.

In some examples, UE sends the Message to NW to request AI data, which includes the indication for AI data type, threshold of AI data size/number and AI functions indication, there may also be a relationship among AI data type, AI data size and AI function. By this, NW is notified which AI functions needed to collect the AI data, and which types AI data is need to be transferred and how much this AI data type is need to be transferred.

In some examples, UE sends the Message to NW to request AI data, which includes the indication for AI data type and duration of AI data collection, there may also be a relationship between them. For this, it implies the initial time, stop time, and duration time of AI data collection to require the AI data information. Then NW is notified which type AI data is needed to collect and how long will the data be collected. Moreover, the granularity of duration of AI data collection can be also defined: 1) based on the unit of time: for example: 1 s, or 1 min, or 1 hour, or 1 week, or 2 week and so on; 2) based on the latency: the latency can be low, or medium, or high;

In some examples, UE sends the Message to NW to request AI data, which includes indication of quality of AI data, this indication assess the AI data suitable, and/or non-suitable. For example, For model inference, which requires the AI data should be collected in a short time, such through defining a threshold to judge whether the AI data is suitable, if the collected AI belong to scope of threshold, such as 1 hour, it seems that AI data is collected. The quality of AI data can be based on time, or size, or accuracy, or latency, or source destination and so on.

Moreover, the above parameters in Message can be by indicator, and/or string, and/or bitmap, and the Message may be transfer in dedicated RRC message, PUSCH, PUCCH, RACH, NAS and etc., the Message may be transfer in system information, dedicated RRC message, UP traffic, NAS and etc. The AI data collection can be periodic, or on-demand, or event trigger.

### Embodiment2: The Procedure of NW Collects Data from Active UE

AI functions located in NW which is needed to collect AI data, there are two alternatives for NW to gather AI data information from UE.

Alternative1: NW initial: through NW send a request message to UE for requiring AI data information, UE sends a response to NW according to the configuration information in request message, the AI data information is provided in the response message;

Alternative2: UE autonomous: through UE autonomously sends AI data information to NW.

The procedures of above alternatives are shown in FIGS. 5A, 5B. In Alternative1, as depicted in FIG. 5A, the procedure of NW collects AI data information is provided as follows:

Step1: NW sends Message to UE, which is used to request AI data information from UE. The Message can be newly defined, and/or reused legacy message, Message includes at least one of the followings:
Indication for AI data type: which indicates which type of AI data is needed to collect; or
AI function ID: which indicates which AI functions want to collect AI-specific data, such as model training function, model monitoring function, model monitoring function, model update function and etc; or
Cause of AI data: which means the reason for AI data collection.
Threshold of AI data size: which indicates the maximum, and/or minimum /ze/ number of collected AI data; or
Duration of AI data collection: which indicates the maximum, and/or minimum duration of AI data collection; or
Quality of AI data: which indicates the quality of AI data collection, the quality can be described as accuracy, validity and so on; or
Model ID: Which is the indicator for AI model, and/or function of AI model; or
Response type: it indicates the response type can be periodic, aperiodic, event-trigger and so on.

Step2: UE receives the Message with AI data request, it will do a decision, the decision can be send the AI data information to NW, or suspend the AI data transfer, or reject the AI data request.

Step3: UE sends the response in Message to NW. If the UE agree to report the AI data to UE, the Message may carry the required AI data information, if the UE reject to report the AI data to NW, the Message may carry the reject reason.

In Alternative2, as depicted in FIG. 5B, the data collection procedure of NW is provided as follows:
Step1: UE sends the AI data information in message to NW, the content of AI data can be decided by NW self, or fixed. The content of AI data may be: CQI, PMI, RI, CIR, L1-RSRP, Beam ID, NW location information, cell ID, area ID, site ID, scenario ID, zone ID, carrier frequency, accuracy and so on.

Some examples are similar as embodiment, while the direction of AI data collection is from UE to NW. Moreover, the above parameters in message can be by indicator, and/or string, and/or bitmap, and the message can be transfer in system information, dedicated RRC message, RACH and etc, the message can be transfer in PUCCH, PUSCH, dedicated RRC message, UP traffic and etc.

### Embodiment3: The Procedure of NW Collect Data from Idle/Inactive UE

AI functions located in NW which is needed to collect AI data, there are two alternatives for NW to gather AI data information from idle/inactive UE, There are also two alternatives for NW to gather AI data information:
Alternative1: NW initial: through NW send a request message to idle/inactive UE for requiring AI data information, idle/inactive UE sends a response to NW according to the configuration information in request message, the AI data information is provided in the response message;
Alternative2: UE autonomous: through UE autonomously sends AI data information to NW.

The related procedure and parameters are similar with embodiment 2. However, in some examples for idle/inactive UE, some new indications and actions should be considered because of the type of AI data. More specifically, if the AI data that NW needed that only can be obtained by L1-measurement, such as L1-RSRP, CQI and so on, if the UE agree to report these types of AI data to NW, and if the UE dose not have above AI data in a valid time, it will send an indication for indicting NW initial related measurement of AI data collection to get AI data information since idle/inactive can not do the L1-measurement. This new indication is included in message, which can be sent by RACH or dedicated RRC message. If the AI data that NW needed that only can be obtained is obtained by L1 measurement, such as RSRP, RSRQ, SINR, if the UE has it at a valid time, and/or if the AI data that NW needed that only can be obtained is obtained by non-measurement, such as cell ID, UE location, site ID, accuracy, prediction result and so on, these AI data information can be sent to NW has the following ways:
Opt1: idle/inactive UE send the AI data information to NW by RACH or grant free transmission, while idle/inactive UE does not need to transmit active UE;
Opt2: idle/inactive UE send the AI data information to NW by RRC dedicated, and/or UP traffic, while the idle/inactive UE needs to transmit active UE and establish the connection between UE and NW;
In order to assist UE to decided use which above options to transmit AI data information, a new threshold should be defined, which may be based data size. For example, if the AI data size is larger than the new threshold, UE may report the AI data used opt2, or the AI data size is smaller than the new threshold, UE may report the AI data used opt1; or if the AI data size is larger than the new threshold, UE may report some AI data used opt1 and some AI data used opt2,

To sum up the above discussion
a new indication is defined, which is used to indicate NW to initiate AI data collection measurement;
a new threshold is defined, which indicates which type messages carried the AI data information.

A new RACH scenario should be defined, which is for AI data collection from the idle/inactive UE;

Note that 2) is also suitable to active UE.

FIG. 2A illustrates a method 200 for determining an artificial intelligence (AI)/machine learning (ML) model in a wireless communication system based on information according to an embodiment of the present disclosure. In some embodiments, the method 200 includes: a block 202, receiving the information from a first node and/or a second node by a third node, wherein the information is used for the third node to determining the AI/ML model in the wireless communication system.

### Alternative 1: Model ID for Model Selection

The RRC complete message may include at least one of the following assistant information: UE ID,.

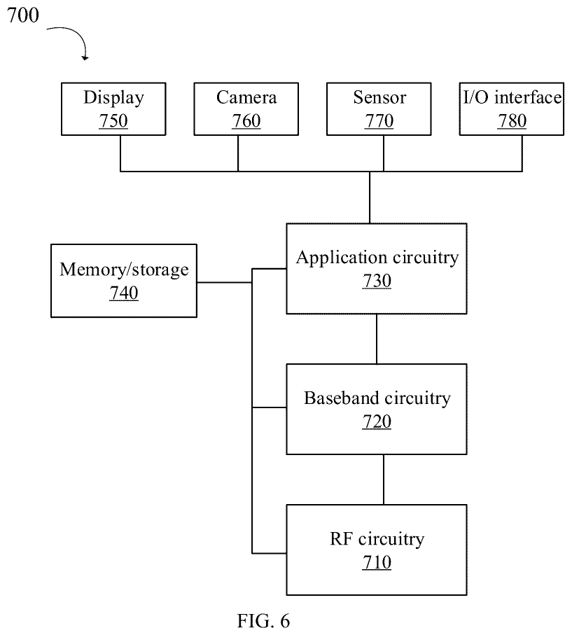

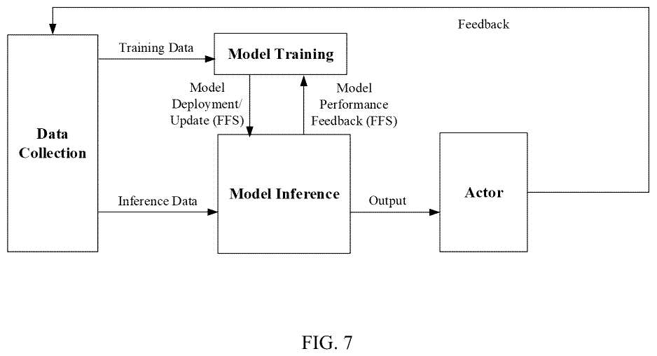

FIG. 6 is a block diagram of an example system 700 for wireless communication according to an embodiment of the present disclosure. Embodiments described herein may be implemented into the system using any suitably configured hardware and/or software. FIG. 6 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for collecting artificial intelligence (AI)/machine learning (ML) data information in wireless communication system, comprising:
User equipment (UE) sending a message to network (NW), wherein the message is used to request some AI data information from NW, wherein the message is sent by a newly defined and/or a reused legacy message, wherein the operation of UE sends a message to NW is optional;
UE receiving a message with response from NW, wherein the message with response carries required AI data information.

2. (canceled)

3. A method for collecting artificial intelligence (AI)/machine learning (ML) data information in wireless communication system, comprising:
Network (NW) sends sending a message to user equipment (UE), wherein the message is used to request some AI data information from UE, wherein the message is sent by system information, or/and dedicated RRC message, wherein the operation of NW sends a message to UE is optional;
NW receives receiving a message with response from UE, wherein the message with response carries required AI data information.

4. A method for collecting artificial intelligence (AI)/machine learning (ML) data information in wireless communication system, comprising:
User equipment (UE) receiving request message with AI/ML data request from network (NW), wherein the operation of UE receives request message is optional;
UE sending a message with response to NW, wherein the message with response carries required AI data information.

5. The method for collecting the AI/ML data in the wireless communication system according to claim 3, wherein for procedure of NW collect data from idle/inactive UE, the method comprises:
for NW initial, NW sending a request message to idle/inactive UE for requiring AI data information, and receives a response from idle/inactive UE according to configuration information in request message, wherein the AI data information is provided in response message.

6. The method for collecting the AI/ML data in the wireless communication system according to any one of claim 4, wherein for procedure of NW collect data from idle/inactive UE, the method comprises:
UE autonomous: UE autonomously sending AI data information to NW.

7. The method for collecting the AI/ML data in the wireless communication system according to claim 5, wherein if AI data type that NW needed only is obtained by L1-measurement, and if the UE report these types of AI data to NW, UE sends an indication for triggering NW initial related measurement of AI data collection to get the AI data information, wherein the indication is included in the message with response and sent by RACH or dedicated RRC massage.

8. The method for collecting the AI/ML data in the wireless communication system according to claim 5, wherein if AI data that NW needed only obtained by L3-measurement or/and non-measurement, the AI data information can be is sent to NW as at least one of the following options:
wherein idle/inactive UE sends AI data information to NW by RACH or grant free transmission, while idle/inactive UE does not need to be transmitted active UE;
wherein idle/inactive UE sends AI data information to NW by RRC dedicated, and/or UP traffic, while idle/inactive UE needs to transmit active UE and establish connection between UE and NW.

9. The method for collecting the AI/ML data in the wireless communication system according to claim 8, further comprising a new threshold defined to assist UE to decided use which options to transmit AI data information, wherein new threshold is based on data size.

10. The method for collecting the AI/ML data in the wireless communication system according to claim 4, wherein the message used to request some AI data information comprises at least one of the followings:
indication for AI/ML data type, indicating which type of AI/ML data is needed to collect;
AI/ML function ID, indicating which AI functions want to collect AI/ML-specific data such as a model training function, a model monitoring function, a model monitoring function, and/or a model update function;
cause of AI/ML data, indicating a reason for AI/ML data collection;
threshold of AI/ML data size, indicating a maximum, and/or a minimum size/number of collected AI/ML data;
duration of AI/ML data collection, indicating a maximum, and/or a minimum duration of AI/ML data collection;
quality of AI/ML data, indicating a quality of AI/ML data collection described as accuracy or validity;
model ID, indicating AI/ML model and/or function of AI/ML model; and/or
response type, indicating a response type is periodic, aperiodic, or event-trigger.

11. The method for collecting the AI/ML data in the wireless communication system according to claim 4, wherein content of AI data is decided by NW or UE itself or fixed.

12. The method for collecting the AI/ML data in the wireless communication system according to claim 4, further comprising at least one of options to indicate AI data type:
wherein the UE indicates AI data type precisely, wherein an indication clearly indicates one type of required AI data;
wherein the UE indicates a set/group of required AI-specific data type, wherein an indication clearly indicates several types of required AI data, set/group is based on use cases, per cell, per zone, and/or by means of obtaining required AI data.

13. The method for collecting the AI/ML data in the wireless communication system according to claim 4, wherein when NW receives message with AI data request, NW initiates AI-specific measurement operation for data collection, wherein the initiation may be triggered message, and/or a newly defined indication in message, and/or NW delivers AI data directly, which may be based on statistics of NW.

14. The method for collecting the AI/ML data in the wireless communication system according to claim 4, wherein message sent by UE to NW to request AI data comprises threshold of AI data size/number, wherein threshold of AI data size/number is defined as at least one of following:
wherein AI data size threshold is fixed by analysis and evaluation;
UE calculate, wherein UE calculates minimum AI data size which it needs and maximum AI data size which it can store, wherein the calculation is based on UE capability, memory, reminding required type AI data that UE has store, or use cases.

15. The method for collecting the AI/ML data in the wireless communication system according to claim 4, wherein parameters in message is by indicator, string, and/or bitmap, and message transfers in dedicated RRC message, PUSCH, PUCCH, RACH, NAS and etc., response message transfers in system information, dedicated RRC message, UP traffic, NAS and etc., wherein AI data collection is periodic, on-demand, or event trigger.

16-21. (canceled)

22. The method for collecting the AI/ML data in the wireless communication system according to claim 1, wherein for procedure of NW collect data from idle/inactive UE, the UE autonomously sends AI data information to NW.

23. The method for collecting the AI/ML data in the wireless communication system according to claim 22, wherein if AI data type that NW needed only is obtained by L1-measurement, and if the UE report these types of AI data to NW, UE sends an indication for triggering NW initial related measurement of AI data collection to get the AI data information, wherein the indication is included in the message with response and sent by RACH or dedicated RRC massage.

24. The method for collecting the AI/ML data in the wireless communication system according to claim 22, wherein if AI data that NW needed only obtained by L3-measurement or/and non-measurement, the AI data information is sent to NW as at least one of the following options:
wherein idle/inactive UE sends AI data information to NW by RACH or grant free transmission, while idle/inactive UE does not need to be transmitted active UE;
wherein idle/inactive UE sends AI data information to NW by RRC dedicated, and/or UP traffic, while idle/inactive UE needs to transmit active UE and establish connection between UE and NW.

25. The method for collecting the AI/ML data in the wireless communication system according to claim 24, wherein a new threshold is defined to assist UE to decided use which options to transmit AI data information, wherein new threshold is based on data size.

26. The method for collecting the AI/ML data in the wireless communication system according to claim 1, wherein the message used to request some AI data information comprises at least one of the followings:
indication for AI/ML data type, indicating which type of AI/ML data is needed to collect;
AI/ML function ID, indicating which AI functions want to collect AI/ML-specific data such as a model training function, a model monitoring function, a model monitoring function, and/or a model update function;
cause of AI/ML data, indicating a reason for AI/ML data collection;
threshold of AI/ML data size, indicating a maximum, and/or a minimum size/number of collected AI/ML data;
duration of AI/ML data collection, indicating a maximum, and/or a minimum duration of AI/ML data collection;
quality of AI/ML data, indicating a quality of AI/ML data collection described as accuracy or validity;
model ID, indicating AI/ML model and/or function of AI/ML model; and/or
response type, indicating a response type is periodic, aperiodic, or event-trigger.

27. The method for collecting the AI/ML data in the wireless communication system according to claim 1, wherein content of AI data is decided by NW or UE itself or fixed.
